(19) United States
(12) Patent Application Publication
(10) Pub. No.: US 2003/0076528 A1
(43) Pub. Date: Apr. 24, 2003

(54) Network system and method for automatic printing of digital photographs

(76) Inventors: Travis J. Parry, Boises, ID (US); Robert Sesek, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/037,685

(22) Filed: Oct. 24, 2001

(51) Int. Cl. G06F 3/12; G06F 15/00

(52) U.S. Cl. 358/1.15

(57) ABSTRACT

A system and method of automated printing of an image posted to a network site is described. The method includes defining a print criterion. A user printer is registered with the network site. It is determined if the image has been posted to the network site, and if the image has been posted to the network site, capturing the image from the network site to the user printer. The image is automatically printed on the user printer according to the print criterion.

This patent application is related to Non-Provisional U.S. patent application Ser. No. ______, entitled “Auto Post from a Digital Camera”, having Attorney Docket No. 10006775-1, filed on even date herewith, assigned to the assignee of the present invention, and incorporated herein by reference.

The Field of the Invention The present invention generally relates to a system and method for automated printing of images posted to a network site, and in particular, to the automatic downloading of images from a selected website to a user printer, which automatically prints the images according to a print criterion predefined by a user.

### BACKGROUND OF THE INVENTION

The Internet is a multimedia computer communications network built on worldwide telephone and data networks. Hundreds of thousands of servers are connected to the Internet, providing a publicly accessible distributed data store. Data is stored on servers in “web pages.” A collection of web pages comprise a “website.” Together these websites form the “World-Wide Web,” or simply the “WEB.” Information held on the WEB and intended for public access is accessible to anyone having a computer connected to the Internet. The WEB search process is known as ‘surfing’. Access to certain information may be restricted by means of closed user groups. A Uniform Resource Locater (URL) has been adopted as a WEB standard to provide a consistent international naming convention to uniquely identify the location of any WEB resource, including photographs, images, programs, recordings, video clips or documents. URL identified files (web pages) can be located and transferred for reproduction on user equipment connected to the Internet.

Internet Service Providers (ISP) lease server capacity to enable a registered user to establish their own “site” on the Internet, identifiable by a unique URL, to store their own WEB pages (or the WEB pages of others) and make them available to other Internet users. Internet users may access information on the WEB using proprietary WEB browser products running on personal computers (PCs) or workstations linked to the Internet. Automated systems, which retrieve website content are known in the art. This includes, for example, NewspaperDirect® at http://www.newspaperdirect.com, which delivers newspapers stored on web pages to a facsimile machine or printer. Users may subscribe to this news service.

Users often want to share photographs through the Internet, as for example, family wedding photographs or genealogical photographs, etc. Photographs can be digitized by means of a digital camera or a scanner, stored as electronic images, and shared through the Internet via a website or e-mail attachments. Photo finishing companies such as Eastman Kodak® and Ritz Camera® have systems for users to store, share and print photographs. Kodak's® PhotoNet^{SM} Online at http://www.kodak.com operates in conjunction with the ISP, America Online (AOL). A customer's developed film is posted to a website accessed by signing onto AOL and clicking the “You've Got Pictures” button to view the photographs. The photographs can then be e-mailed to friends and family, or printed. Others can be invited to view, download, print, or order high quality reprints. Ritz Camera® has a similar system.

The Ritz Camera® system is described at http://www.ritzcamera.com. Customers are given a password along with their developed film. The customer logs on to the http://www.ritzPIX.com home page and provides their film roll ID number and password, after which their photographs are displayed. Others can be invited via e-mail to view, download, print, or order high quality reprints. Customers can also upload their digital photographs from their computer to a ritzPIX.com storage folder for long-term storage.

The Microsoft Network, through http://communities.msn.com, offers a service whereby a user can establish a site with photographs and send e-mail invitations to others to come and view/download/print the photographs. Users can also subscribe to sites and receive e-mail notices whenever new activity takes place on the site.

In the past, the process of downloading and printing images, such as photographic content, involved signing on to the selected website, observing whether any additional images had been added since the last visit (or receiving an e-mail of new content), then downloading and either storing or printing the images on the user's system. To print, appropriate print options had to be selected each time, e.g., size, resolution etc. Not all users are sufficiently proficient with the Internet, however, to expeditiously accomplish this process. What is needed is a simple automated system, which will detect when new images have been added to a selected website, and automatically download and print them to a user's printer according to a user's previously selected options, all without user intervention.

### SUMMARY OF THE INVENTION

The present invention provides a system and method of automated printing of an image posted to a network site. In one embodiment, the method includes defining a print criterion. A user printer is registered with the network site. If it is determined that an image has been posted to the network site then the image is captured from the network site to the user printer, and the image is automatically printed on the user printer.

### BRIEF DESCRIPTION OF THE DRAWINGS

FIG. 1 is a block diagram illustrating one exemplary embodiment of automated printing of an image posted to a network site according to the present invention.

FIG. 2 is a block diagram illustrating one exemplary embodiment of information flow through a portion of the automated printing system of FIG. 1.

FIG. 3 is a diagram illustrating one exemplary embodiment of a user interface for use with the automated printing system, according to the present invention.

FIG. 4 is a diagram illustrating one exemplary embodiment of a printing system controller portion of a user printer.

FIG. 5 is a diagram illustrating one exemplary embodiment of a web access mechanism portion of a user printer.

FIG. 6 is a diagram illustrating one exemplary embodiment of an image list compiled by the network site used to track images posted to the network site.

FIG. 7 is a diagram illustrating one exemplary embodiment of a master image list compiled and maintained by the user printer used with the automated printing system according to the present invention.

FIG. 8 is a diagram illustrating one exemplary embodiment of an image request generated and submitted by the user printer used with automated e-picture printing system of FIG. 1.

FIG. 9 is a flow diagram illustrating one exemplary embodiment of automated printing of an image posted to a network site according to the present invention.

### DESCRIPTION OF THE PREFERRED EMBODIMENTS

In the following detailed description of the preferred embodiments, reference is made to the accompanying drawings, which form a part hereof, and in which is shown by way of illustration, specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

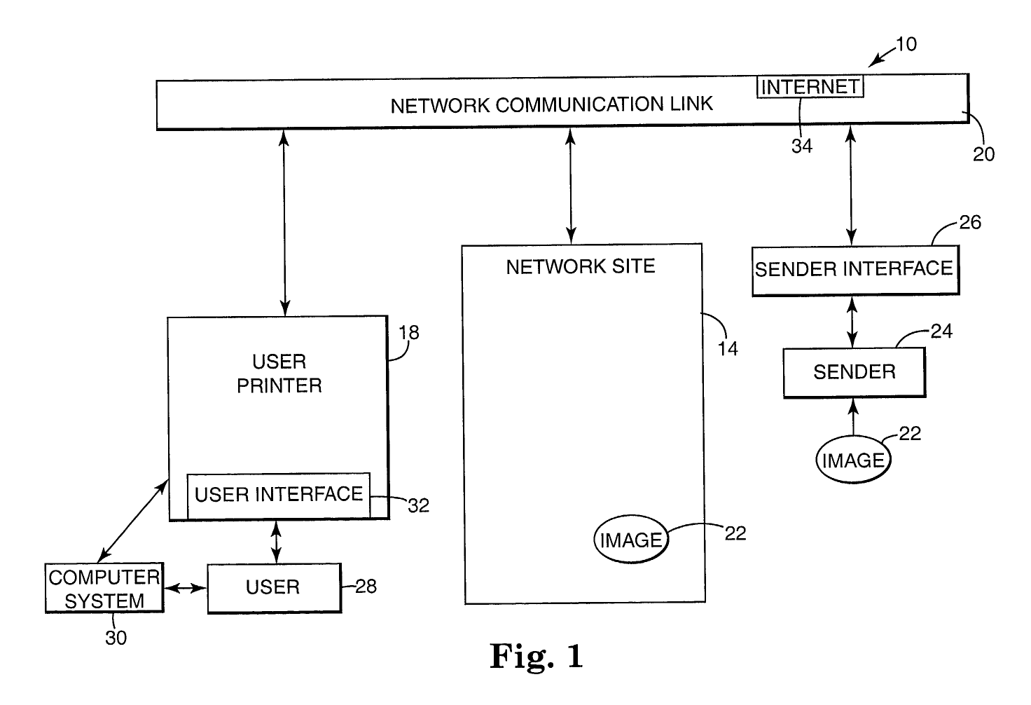

A system and method for automated printing of digital photographs (i.e., “e-pictures”) posted to a network site according to the present invention is illustrated generally at 10 in FIG. 1. Automated printing system 10 automatically transfers an image posted to a network site by a sender to a user printer. In particular, automated e-picture printing system 10 automatically captures image(s) from the network site registered with the user printer and then prints image(s) on the user printer, thereby automatically delivering the image(s) to a user. The image(s) are printed according to print criterion predefined by the user.

The term “image,” as used herein, is defined to include a photograph and/or other digital or electronic image. Image may be one or more images or subset of images posted to a network site. The term “network site,” as used herein, is defined to include a website. The term “user,” as used herein, is defined to include an entity or entities such as a consumer, an employee, or another entity capable of offering, providing, publishing, and/or posting an image to an automated printing system according to the present invention. The term “user printer” represents a wide variety of devices including devices such as printers, multifunctional printers (MFP's), fax machines, copiers, hardcopy imaging devices, communication and telephony devices. User printer may be one or more of such devices. In a preferred embodiment, user printer, as used herein, includes a network-enabled printer with an embedded web access mechanism, and an embedded application. Suitable embedded applications are commercially available under the trade names ChaiServer Embedded Virtual Machine (EVM) and Java Virtual Machine (JVM), which were developed by Hewlett-Packard and Sun Microsystems, respectively. Other web-enabled printers suitable for use with the present invention will become apparent to those skilled in the art after reading the present application. One exemplary embodiment of a network enabled printer with an embedded web access mechanism is disclosed in detail in this application.

FIG. 1 illustrates one exemplary embodiment of automated printing system 10. Automated printing system 10 includes a network site 14 and a user printer 18. Network site 14 and user printer 18 communicate with each other via a network communication link 20. Printing system 10 operates to automatically capture an image 22 from network site 14 and print image 22 on user printer 18. In one aspect, a sender 24 posts image 22 to network site 14 via a sender interface 26. Sender interface 26 interacts with network site 14 via network communication link 20. In one aspect, printing system 10 operates to automatically capture and print image 22 from network site 14.

In one embodiment, a user 28 defines a print criterion via a computer system 30, which includes an input device such as a keyboard and/or a mouse and a display device such as a monitor, as is known in the art. Computer system 30 communicates with user printer 18 to enable user 28 to access a user interface 32. It is, however, within the scope of the present invention for network site 14 to communicate with user printer 18 in other manners (e.g., via a direct connection or wireless communication link). In one embodiment, user printer 18 includes user interface 32, which allows user 28 to predefine a print criterion directly through user printer 18. In another embodiment, user interface 32 is located remote from user printer 18, such as part of computer system 30.

User printer 18 is registered with network site 14. Automated printing system 10 determines if image 22 has been posted to the network site 14. If image 22 has been posted to network site 14, image 22 is captured from network site 14 to user printer 18, which automatically prints image 22 for delivery to user 28.

Network communication link 20, as used herein, is defined to include an internet communication link (e.g., the Internet), an intranet communication link or other high-speed communication link. In one preferred embodiment, network communication link 20 is capable of transferring HTML files according to the HTTP web protocol. In one preferred embodiment, network communication link 20 includes an Internet communication link 34. While the following description refers to an Internet communication link 34, it is understood that the use of other network communication links is within the scope of the present invention. In one embodiment, network site 14 and user printer 18 are located remote from each other. Thus, communications between network site 14 and user printer 18 are conducted over network communication link 20. It is, however, within the scope of the present invention for network site 14 to communicate with user printer 18 in other manners (e.g., via a direct or wireless connection).

Automated printing system 10 can be implemented in hardware via a microprocessor, programmable logic device or state machine, in firmware, or in software. In one embodiment, a portion of the software programming is written in JAVA™ programming language and each of the main components communicates via network communication link 20 using a communication bus protocol. For example, the present invention may or may not use a TCP/IP protocol suite for data transport. Other programming languages and communication bus protocols suitable for use with automated printing system according to the present invention will become apparent to those skilled in the art after reading the present application.

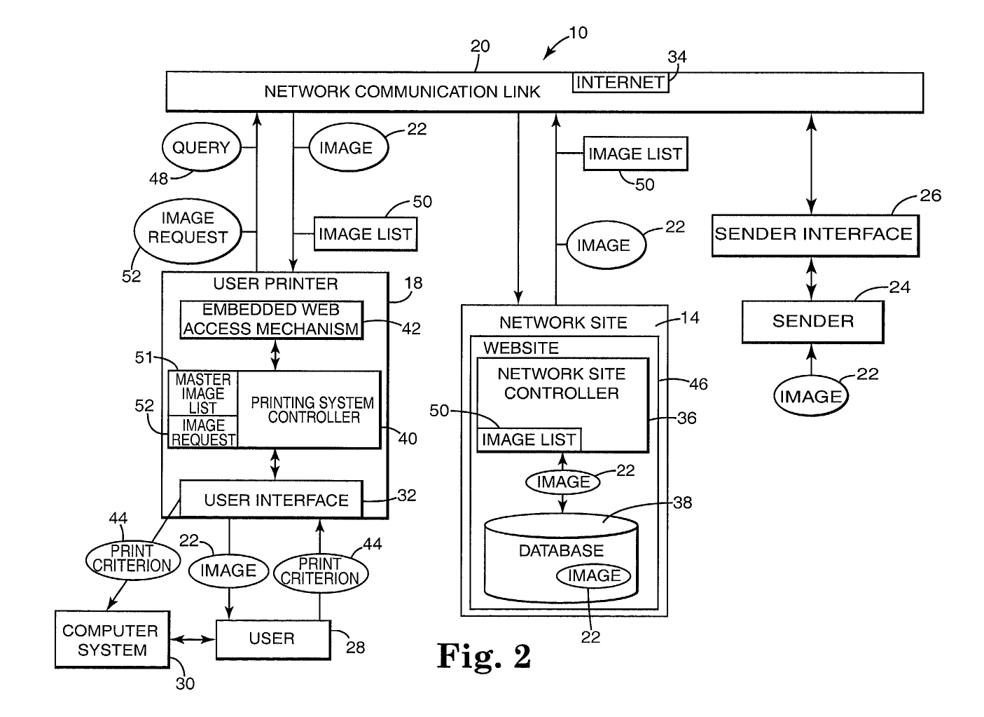

FIG. 2 illustrates one exemplary embodiment of information flow through a portion of automated printing system 10. Network site 14 interacts with user printer 18 via Internet communication link 34 to identify image 22 and deliver image 22 to user 28. In one embodiment, network site 14 includes a network site controller 36 and a database 38. When sender 24 posts image 22 to network site 14, image 22 is tracked by network site 14 via network site controller 36 and stored in database 38. Once image 22 is posted to network site 14 and stored in database 38, image 22 may be viewed by user 28 when user 28 logs on to network site 14 via computer system 30. In one embodiment, image 22 is transferred to and from database 38, which includes a web page, via network site controller 36.

Network site controller 36 includes hardware, software, firmware, or a combination of these. In one embodiment, network site controller 36 includes a computer server or other microprocessor-based system capable of performing a sequence of logic operations. In addition, network site controller 36 can include a microprocessor embedded system/appliance incorporating tailored appliance hardware and/or dedicated single purpose hardware.

Network site controller 36 facilitates communication between sender 24 and user 28 by tracking registration of network site members and maintaining an image list of images posted to network site 14 by sender 24 and stored in database 38. Examples of database 38 include non-volatile memory (e.g., a hard disk drive or other persistent storage device) and may include volatile memory (e.g., random access memory (RAM)).

In one embodiment, user printer 18 includes hardware, software, firmware, or a combination of these. In one embodiment, user printer 18 also includes user interface 32, a printing system controller 40 and an embedded web access mechanism 42. User 28 interacts with a user interface 32 to define a print criterion 44 for automated printing of image 22 on user printer 18. Print criterion 44, as described below, identifies attributes specified by user 28 for automated capturing and printing of image 22 on user printer 18.

User printer 18 interacts with network site 14 according to print criterion 44 predefined by user 28. Network site 14, as used or defined herein, includes a website 46. While the following description only refers to website 46, it is understood that the use of other network sites is within the scope of the present invention. Once user 28 has registered with website 46, user printer 18 interacts with website 46 according to print criterion 44 to determine if image 22 has been posted to website 46. If user printer 18 determines that image 22 has been posted to website 46, user printer 18 automatically captures image 22 from website 46. In particular, user printer 18 sends a query 48 to website 46 to retrieve an image list 50 from website 46. If user printer 18 determines by comparing image list 50 with a master image list 51 that image 22 has not been captured to user printer 18, user printer 18 generates and submits an image request 52 to website 46 via Internet communication link 34. After the network site receives image request 52, image 22 is transferred from network site 14 to user printer 18 via Internet communication link 34. In one aspect, network site 14 pushes image 22 to user printer 18. In another aspect, user printer 18 pulls image 22 from network site 14.

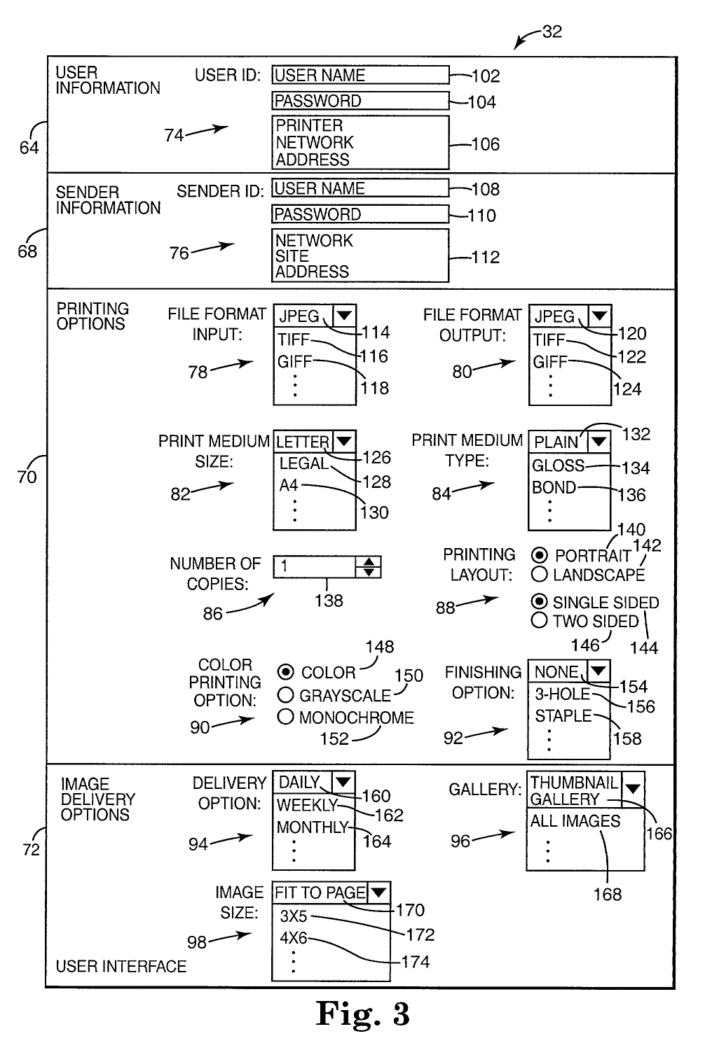

FIG. 3 is one exemplary embodiment of a portion of user interface 32. User interface 32 includes a plurality of input fields with which user 28 interacts to define print criterion 44. User interface 32 includes a user information category 64, a sender information category 68, a printing options category 70, and an image delivery options category 72. As such, user 28 interacts with the input fields via an input device such as a keyboard and/or mouse of computer system 30, to register print criterion 44 for capturing image 22 from network site 14 and automatically delivering image 22 to user 28 by printing image 22 to user printer 18. The input fields include for example, a user identification field 74, a sender identification field 76, a file format input field 78, a file format output field 80, a print medium size field 82, a print medium type field 84, a number of copies field 86, a printing layout field 88, a color printing option field 90, finishing option field 92, delivery option field 94, a gallery field 96, and an image size field 98. The input fields each include at least one subfield providing data entry points or representing available options for capturing and automatically printing image 22 to user printer 18.

User information category 64 includes, for example, user identification field 74 with subfields 102, 104 and 106, which provide data entry points for a user name, password, and printer network address, respectively, of user 28. Sender information category 68 includes, for example, sender identification field 76 with subfields 108, 110 and 112 for user name, password, and a network site address, respectively.

Printing options category 70 includes, for example, file format input field 78, file format output field 80, print medium size field 82, print medium type field 84, number of copies field 86, print layout field 88, color printing option field 90, and finishing option field 92. File format input field 78 includes, for example, subfields 114, 116 and 118, which represent different file formats for image 22 when retrieved from network site 14. File format output field 80 includes, for example, subfields 120, 122 and 124, which represent different file formats for image 22. Print medium size field 82 includes, for example, subfields 126, 128, 130, which represent different sizes of print medium for image 22. Print medium type field 84 includes, for example, subfields 132, 134 and 136, which represent different types of print medium for image 22. Number of copies field 86 includes subfield 138 in which a number of copies of image 22 to be printed is specified. Printing layout field 88 includes, for example, subfields 140, 142, 144 and 146, which represent different printing layouts for a print job. Color printing option field 90 includes, for example, subfields 148, 150 and 152, which represent different color printing options for image 22. Finishing option field 92 includes, for example, subfields 154, 156 and 158 that represent finishing options for image 22. Image delivery options category 72 includes, for example, delivery option field 94, gallery field 96, and image size field 98. Delivery option field 94 includes, for example, subfields 160, 162, and 164, which represent how often user printer 18 captures image 22 from network site 14 and automatically delivers image 22 to user 28. Gallery field 96 includes, for example, subfields 166 and 168, which represent the type of image 22 to be captured from network site 14. Image size field 98 includes, for example, subfields 170, 172, and 174, which represent the size of image 22.

Additional file formats, print medium sizes, print medium types, printing layouts, color printing options, finishing options, and delivery options, may be represented by additional subfields of file format input field 78, file format output field 80, print medium size field 82, print medium type field 84, number of copies field 86, printing layout field 88, color printing option field 90, finishing option field 92, delivery option field 94, gallery field 96, and image size field 98, respectively. Selecting and/or completing various subfields define print criterion 44 for capturing image 22 from network site 14 and automatically printing image 22 to user printer 18.

It is to be understood that FIG. 3 is a simplified illustration of one exemplary embodiment of user interface 32. The illustrative presentation of categories and input fields, including respective subfields, for example, has been simplified for clarity of the invention. The subfields may be presented, for example, as open fields, pull-down menus, toggle selections, and/or highlighted or framed selections. In addition, user interface 32 may be presented, for example, in one or more screens, views, or windows. Furthermore, user 28 may define print criterion 44 by responding to query-based systems or applications. It is understood that such alternatives are within the scope of the present invention.

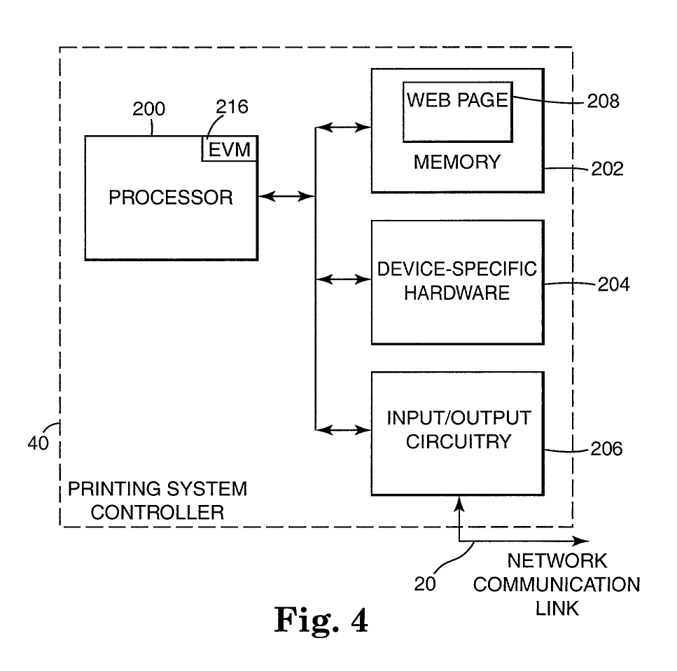

FIG. 4 illustrates one exemplary embodiment of printing system controller 40. In one embodiment, printing system controller 40 includes a processor 200, a memory 202, device-specific hardware 204 (e.g., printer hardware and associated circuitry), and input/output circuitry 206 that enables communication via network communication link 20. Processor 200 in combination with device-specific hardware 204 performs device-specific functions of user printer 18. In one embodiment, processor 200 stores a printer web page 208 in memory 202, which can also store information about device-specific functions.

FIG. 5 is a diagram illustrating one embodiment of embedded web access mechanism 42 in user printer 18, suitable for use with the present invention. Embedded web access mechanism 42 allows the user printer to communicate with network site 14 independent of computer system 30. In one embodiment, embedded web access mechanism 42 includes, for example, a display or monitor 210, a printer web page 208, a printer web server 212, and a network interface 214. In one embodiment, processor 200 together with software or firmware for processor 200 function as printer web server 212. In one embodiment, the software or firmware for processor 200 that creates web server functionality is a ChaiServer Virtual Machine 216 (hereinafter “EVM 216”). EVM 216 is a programming environment that enables user printer 18 to execute JAVA applications on any processor regardless of an operating system used.

Suitable web access mechanisms for use with the present invention are disclosed in U.S. Pat. No. 5,956,487 to Veukatraman et al. for “Embedding Web Access Mechanism in an Appliance for User Interface Functions Including a Web Server and Web Browser” issued Sep. 21, 1999, and U.S. Pat. No. 6,170,007 to Veukatraman et al. for “Embedding a Web Access Functionality into a Device for User Interface Functions” issued Jan. 2, 2001 both of which are incorporated herein by reference. Both of these patents include a system by which a device such as printer 18 can accept, store and print images downloaded from the Web. Web access functionality is embedded in a device to enable low cost widely accessible and enhanced user interface functions for the device. In one embodiment, user 28 accesses automated e-picture printing system 10 by launching printer web page 208. Printer web server 212 provides access to user interface 32 via printer web page 208. Network interface 214 enables access to printer web page 200 by any web browser such that user 28 accesses user interface 32 via printer web page 208 and image 22 is transferred from network site 14 to user printer 18 via printer web page 208.

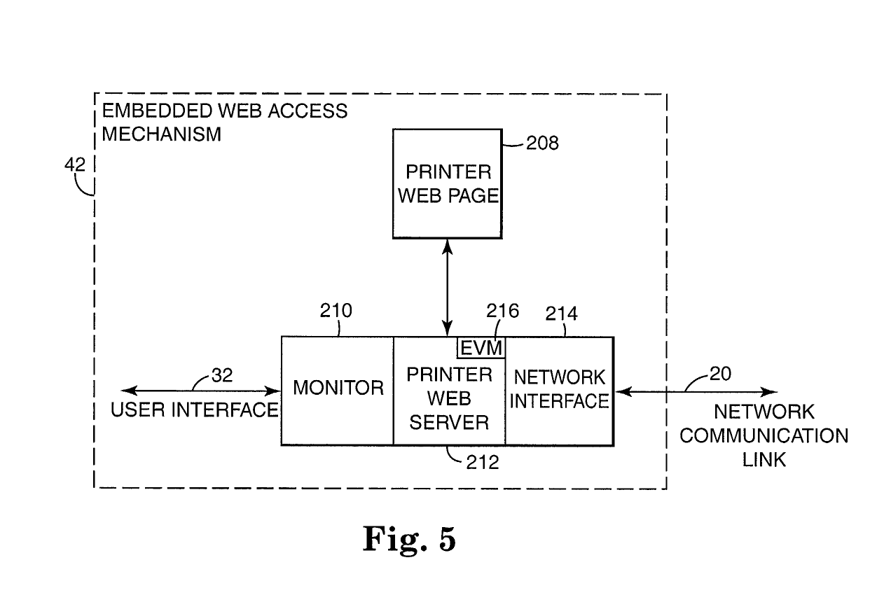

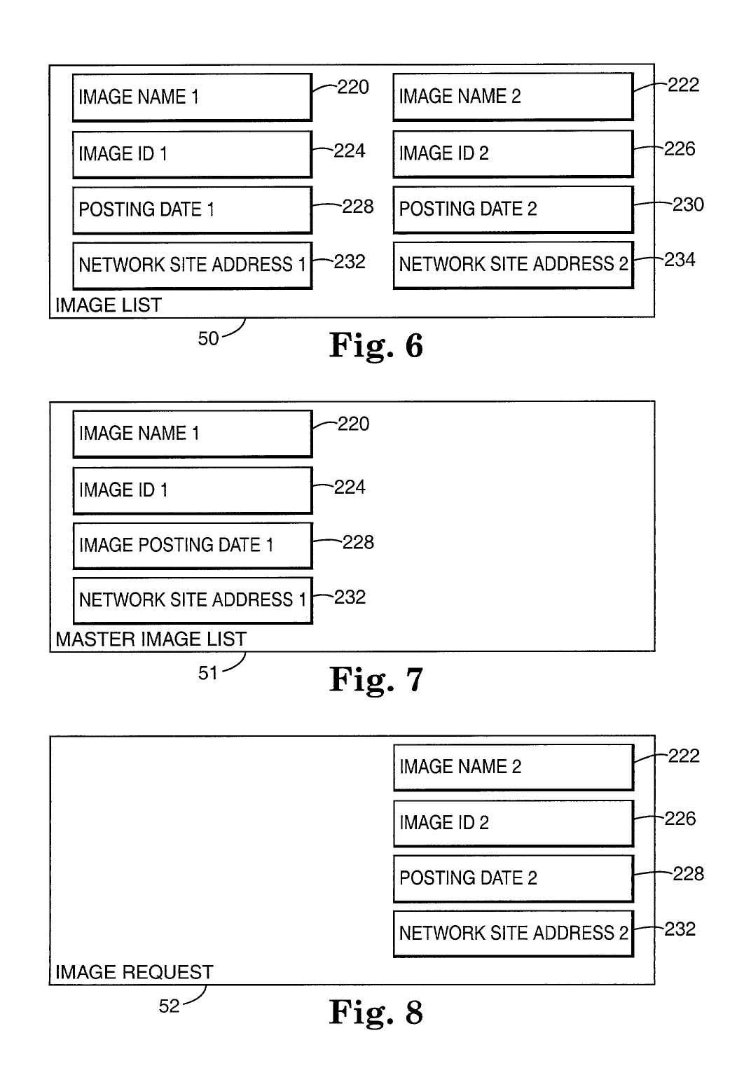

FIGS. 6 through 8 are exemplary embodiments of image list 50, master image list 51, and image request 52, respectively. In one embodiment, user printer 18 determines if new images have been posted to network site 14 and identifies image 22 as a new image by comparing image list 50 with master image list 51. Image list 50 is used by network site 14 to track images posted to network site 14 and lists all images posted to network site 14. In one embodiment, image list 50 includes, for example, an image name 220 and 222, an image identification 224 and 226, an image posting date 228 and 230, and a network site address 232 and 234.

In one exemplary embodiment, master image list 51, as illustrated in FIG. 7, is used by user printer 18 to track images already captured and downloaded from network site 14. In one embodiment, master image list 51 includes image name 220, image identification 224, image posting date 228, and network site address 232. The information included in image list 50 corresponds to information tracked by user printer 18 in master image list 51.

In one embodiment, image identification 224 is defined as a cyclic redundancy code (CRC), which is an error detection code, whereby any change in a file size of image 22 can be detected by comparing image identification 224 of each image 22. A unique image identification 224 is generated for each image format with a given resolution. For example, if the resolution of image 22 is increased or decreased, the size of the file corresponding to image 22 is increased or decreased, respectively, thereby changing image 22. Changing image 22 causes a different CRC to be generated and attached to image 22. This allows user printer 18 to determine if image 22 has been modified or is a new image even if image name 220 corresponds to more than one image 22.

User printer 18 can compare master image list 51 with image list 50 retrieved from network site 14 to determine if new images have been posted to network site 14 and identify image 22 as a new image. In this example, image name 222, image identification 226, image posting date 230 and network site address 234 correspond to and identify image 22 as a new image that has not been captured and delivered to user 28. Once image 22 has been identified as a new image, user printer 18 captures image 22 by generating and sending image request 52 to network site 14. In one embodiment, image request 52 includes image name 222, image identification 226, image posting date 228, and network site address 232 that identify image 22.

Other suitable methods may be used for determining whether a posted image has been transferred to user printer 18. In one alternate embodiment, network site 14 maintains a single master image list, which allows network site 14 to track if image 22 has already been transferred to a given user printer 18, thereby eliminating the need for user printer 18 to maintain a monotonically increasing list or differentiate between images posted by different senders.

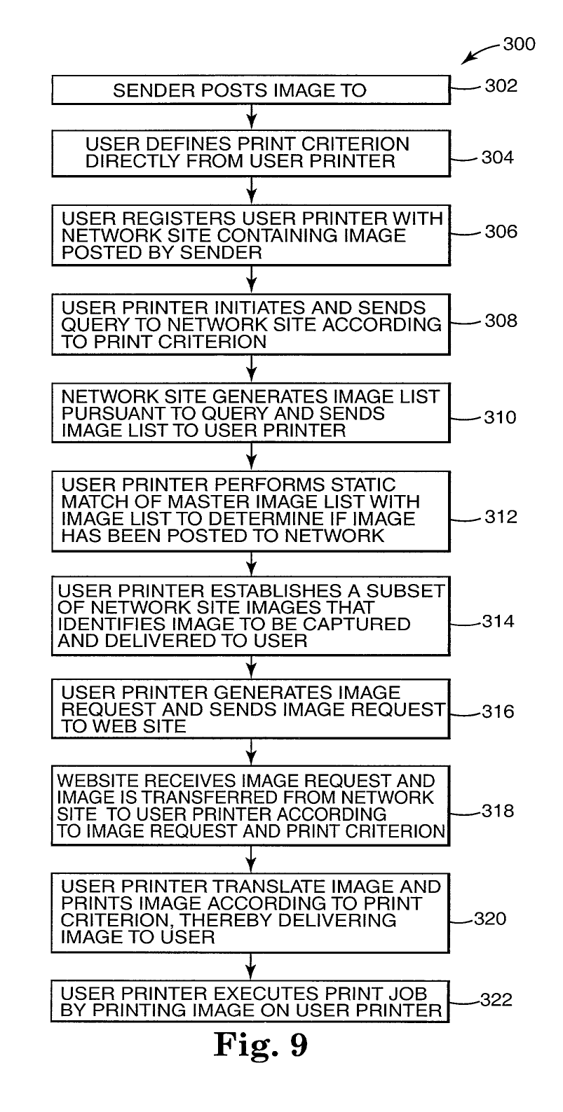

FIG. 9 is a flow diagram illustrating one exemplary embodiment of a method of automated printing of image 22 posted to network site 14 to user printer 18. The method of automated printing of image 22 posted to network site 14 to user printer 18 according to the present invention is illustrated generally at 300. Reference is also made to FIGS. 1-8. At 302, sender 24 posts image 22 to network site 14 via Internet communication link 34. At 304, user 28 defines print criterion 44. At 306, user 28 registers user printer 18 with network site 14, and, at 308, user printer initiates and sends query 48 to network site 14. In one embodiment, user 28 defines print criterion 44 by accessing user interface 32 as illustrated in FIGS. 1 and 2, and user printer 18 initiates and sends query 48 to network site 14 according to print criterion 44 via Internet communication link 34.

Preferably, image 22 is posted to network site 14 at 302 before user printer 18 initiates query 48 to network site 14 at 308. It is, however, within the scope of the present invention for image 22 to be posted to network site 14 after user printer 18 initiates query 48 and for sender 24 to modify images posted to network site 14, by adding or removing images from network site 14. In addition, it is also within the scope of the present invention for user printer 18 to reinitiate query 48 to network site 14 according to print criterion 44 predefined by user 28.

Next, at 310, after network site 14 receives query 48, network site 14 responds by sending image list 50 to user printer 18 via Internet communication link 34. At 312, when user printer 18 receives image list 50, user printer 18 compares image list 50 with master image list 51 to determine if image 22 (i.e., new image) has been posted to network site 14. In one embodiment, user printer 18 determines if new images have been posted to network site 14 by performing a static match of master image list 51 with image list 50 retrieved from network site 14. At 314, user printer 18 establishes a subset of network site images that identifies image 22 as a new image that has not been printed to user printer 18. To compare image list 50 with master image list 51, images already printed to user printer 18 are compared with all images posted to network site 14. Thus, user printer 18 identifies image 22 as a new image that has not been captured from network site 14 and printed to user printer 18. Only image 22 is identified at 312 and 314. Conversely, images that have been delivered to user 28 are not identified for automatic capture and delivery to user 28. User printer 18, therefore, effectively filters images already captured from network site 14 and delivered to user 28. At 316, after image 22 is identified for automated printing to user printer 18 according to the present invention, user printer 18 generates image request 52, as illustrated in FIG. 8, that is sent to network site 14 to request image 22 according to print criterion 44 predefined by user 28.

Next, at 318, after network site receives image request 52, image 22 is transferred to user printer 18 according to print criterion 44 predefined by user 28. Then, at 320, user printer 18 receives image 22 and translates the input file format specified in file format input field 78 into the file format specified in file format output field 80. Once image 22 has been translated, user printer 18 automatically executes a print job 322, in step 322, by printing image 22 on user printer 18 and, thereby, delivering image 22 to user 28.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of automated printing of an image posted to a network site, the method comprising:
defining a print criterion;
registering a user printer with the network site;
determining if the image has been posted to the network site;
if the image has been posted to the network site, capturing the image from the network site to the user printer; and
automatically printing the image on the user printer according to the print criterion.

2. The method of claim 1, wherein registering the user printer includes defining a printer network address, and wherein defining the printer network address includes defining a unique address associated with the user printer and registering the printer network address with the network site.

3. The method of claim 2, wherein defining the network address includes defining the unique address associated with the user printer as an IP address.

4. The method of claim 1, further including defining a user interface, and wherein defining the print criterion includes defining the print criterion via the user interface.

5. The method of claim 4, wherein defining the print criterion includes at least one of registering user information, sender information, printing options, and image delivery options.

6. The method of claim 5, wherein registering the user information and the sender information includes providing usernames and passwords for a user and a sender, together with the printer network address and the network site address; wherein capturing the image from the network site to the user printer includes logging on to the network site identified by the network site address with the username and the password of the user, and the image being transferred from the network site to the user printer identified by the printer network address.

7. The method of claim 5, wherein registering the printing options includes selecting at least one of a file format input, a file format output, a print medium size, a print medium type, a number of copies, a printing layout, a color printing option, and a finishing option.

8. The method of claim 5, wherein registering the image delivery options includes selecting at least one of a delivery option, a gallery, and an image size.

9. The method of claim 1, wherein registering the user printer, includes defining a network communications link between the user printer and the network site, and registering the user printer with the network site via the network communications link.

10. The method of claim 9, including defining the network site to be a website.

11. The method of claim 10, wherein registering the user printer with the network site includes defining the user printer to include a printing system controller and a web access mechanism.

12. The method of claim 9, wherein capturing the image from the network site to the user printer and automatically printing the image on the user printer include capturing the image via the network communications link.

13. The method of claim 1, wherein determining if the image has been posted to the website includes defining a master image list as a list of downloaded images from the website and comparing the master image list with images posted to the website.

14. The method of claim 12, wherein comparing the master image list with images posted to the website further includes retrieving an image list of images posted to the website.

15. The method of claim 14, wherein retrieving the image list includes the user printer sending a query to the website according to the print criterion via the network communications link.

16. The method of claim 15, wherein comparing the master image list with all images posted to the website includes comparing the master image list with the image list retrieved from the website, generating via the printing system controller an image request that identifies the image to be printed, and updating the master image list to include the image after it has successfully been delivered to the user.

17. The method of claim 16, wherein capturing the image from the website includes the image being transferred from the website to the user printer according to the image request via the network communications link.

18. The method of claim 17, wherein the image being transferred from the website to the user printer includes the website receiving the image request from the user printer via the network communications link.

19. The method of claim 1, wherein automatically printing the image on the user printer, includes translating the image captured from the network site into a print job.

20. The method of claim 19, wherein automatically printing the image on the user printer further includes executing the print job by printing the image on the user printer and thereby delivering the image to the user.

21. A method of automated printing of a digital photograph posted to a website, the method comprising:
defining a print criterion;
registering a user printer with the website;
determining if the digital photograph has been posted to the website;
capturing the digital photograph from the website to the user printer; and
automatically printing the digital photograph on the user printer according to the print criterion.

22. A system for automated printing of an image posted to a network site on a user printer, the system comprising:
a user printer including a printing system controller, an embedded web access mechanism, and a user interface, wherein the user printer is configured to automatically capture and print an image posted to a network site according to a print criterion predefined via the user interface;

23. The system of claim 22, wherein the user printer contains the printing system controller, the embedded web access mechanism with an embedded application allowing the user printer to communicate with the network site regardless of the network site's operating platform, and a user interface.

24. The system of claim 23, wherein the printing system controller includes a processor, a memory, device-specific hardware, and input/output circuitry; wherein the embedded web access mechanism includes a printer web page, a printer web server, and a network interface.

25. The system of claim 24, wherein the web server is adapted to generate the printer web page, wherein the printer web page is configured to provide the user interface, and wherein the user interface is configured to provide a control communications link to the printing controller for defining the print criterion.

26. The system of claim 21, wherein the user printer is configured to communicate with the network site via the network communications link for registering the user printer with the network site, determining if the image has been posted to the network site, and capturing the image from the network site to the user printer.

27. The system of claim 24, wherein the embedded web access mechanism is configured to permit access to the printer web page by the network site via the network communications link.

28. A computer-readable medium having computer-executable instructions for performing a method of automated printing of an image posted to a network site, the method comprising:
defining a print criterion;
registering a user printer with the network site;
determining if the image has been posted to the network site;
if the image has been posted to the network site, capturing the image from the network site to the user printer; and
automatically printing the image on the user printer according to the print criterion.
